(19) United States
(12) Patent Application Publication
(10) Pub. No.: US 2025/0192456 A1
(43) Pub. Date: Jun. 12, 2025

(54) TERMINAL ASSEMBLY

(71) Applicant: Caterpillar Inc., Peoria, IL (US)

(72) Inventors: Nikhilesh Solai, Coimbatore (IN); Saravanan Desigan, Chennai (IN); Sunil Pinnamaneni, Peoria, IL (US); Dean L. Kazubowski, Bradford, IL (US); Brad Lewis Beck, Peru, IL (US)

(73) Assignee: Caterpillar Inc., Peoria, IL (US)

(21) Appl. No.: 18/536,429

(22) Filed: Dec. 12, 2023

(51) Int. Cl. H01R 9/26; H01R 4/34; H01R 9/05; H01R 9/18

(52) U.S. Cl. CPC H01R 9/26; H01R 4/34; H01R 9/05; H01R 9/18; H01R 2201/26

(57) ABSTRACT

A terminal assembly for a cable includes an elongated tongue adapted for connection with a busbar and a tubular body disposed about a central axis. The tubular body has an end-wall integral with one end of the elongated tongue and a recess. The elongated tongue extends from a mid-portion of the end-wall and is co-axial with the central axis. The terminal assembly includes a ferrule coaxial with the tubular body. The ferrule has a tubular portion and a projection adapted for receipt by the recess. The tubular portion defines a cylindrical recess to receive a free end of the cable therein. Further, at least one of the tubular body and the ferrule defines a plurality of external threads. The terminal assembly includes a coupling member defining a plurality of internal threads to engage with the plurality of external threads on at least one of the tubular body and the ferrule.

### TECHNICAL FIELD

The present disclosure relates to a system for creating an electrical junction and, more particularly, to a terminal assembly for a cable.

### BACKGROUND

Machines, such as off-highway trucks, track type tractors, or wheel dozers, include electric power systems or hybrid e.g., fuel-electric power systems that are used to provide power for propulsion, implement movement, or to perform other machine operations. Generally, such power systems include cables for electrically connecting at least two discrete components e.g., an electric motor, an inverter, a generator, or a power distribution unit. The cables may have a diameter that is thick enough to be usable for high-voltage applications. Conventional processes of assembling the cables with a component may be time consuming and may warrant considerable human effort. Moreover, an assembly time of the cable with the component may be dependent on an expertise of an assembly personnel, and a novice assembly personnel may require more time to assemble as compared to an experienced assembly personnel.

U.S. Pat. No. 10,128,615, hereinafter referred to as “the '615 patent”, describes a variable-clocking terminal assembly that includes a crimp barrel, a terminal lug, and a locking collar. The crimp barrel includes a crimp portion having a cavity sized and configured to receive a cable end of an electrical cable. The crimp barrel includes a conical portion extending axially from the crimp portion. The terminal lug has a cylindrical portion and a terminal tongue extending outwardly from the cylindrical portion. The cylindrical portion has a conical cavity configured complementary to the conical portion. The locking collar has collar threads configured to engage threads formed on one of the crimp barrel and the terminal lug for drawing the conical portion into direct physical engagement with the conical cavity in a manner locking an orientation of the terminal lug relative to the crimp barrel and establishing electrical continuity between the conical portion and the conical cavity.

However, the crimp barrel of the '615 patent also describes a conical section and a cylindrical projection extending axially from the conical section. When the crimp barrel engages with the lug, a small portion of the cylindrical projection is exposed. The exposed portion of the cylindrical projection may be susceptible to damage when the machine is used in harsh environments. Further, while the crimp barrel is being connected with the lug, the cylindrical projection may have to be accurately aligned so as to pass the cylindrical projection through the lug.

Furthermore, the lug of the '615 patent includes the cylindrical portion that connects with the crimp barrel and the tongue that connects with the busbar. A portion of the tongue extends angularly from the cylindrical portion. Moreover, the tongue is radially offset relative to a central axis of the lug, such that the tongue that connects to the block is configured to revolve around the central axis, hence the name variable clocking terminal assembly. The terminal assembly of the '615 patent has a complex design, may be cumbersome to handle and assemble, may have a lower surface finish, and may be costly. Moreover, the terminal assembly of the '615 patent may include multiple electrical interfaces. Such multiple electrical interfaces created by the terminal assembly of the '615 patent may reduce a performance of the electrical connection established by the terminal assembly of the '615 patent. Further, the terminal assembly of the '615 patent may not be usable in harsh environmental conditions.

### SUMMARY OF THE DISCLOSURE

In an aspect of the present disclosure, a terminal assembly for a cable is provided. The terminal assembly includes an elongated tongue adapted for connection with a busbar. The terminal assembly also includes a tubular body disposed about a central axis. The tubular body has an end-wall integral with one end of the elongated tongue. The elongated tongue extends from a mid-portion of the end-wall such that the elongated tongue is co-axial with the central axis. The tubular body has a recess extending partway along its length. The terminal assembly further includes a ferrule coaxial with the tubular body. The ferrule has a tubular portion and a projection axially extending therefrom. The projection is adapted for receipt by the recess of the tubular body to contact with the tubular body. The tubular portion defines a cylindrical recess to receive a free end of the cable therein. At least one of the tubular body and the ferrule defines a plurality of external threads. The terminal assembly includes a coupling member defining a plurality of internal threads to engage with the plurality of external threads on at least one of the tubular body and the ferrule to removably secure the ferrule with the tubular body to establish electrical connectivity between the cable and the busbar.

In another aspect of the present disclosure, a system for creating an electrical junction is provided. The system includes a busbar. The system also includes a cable having a free end. The system further includes a terminal assembly for the cable. The terminal assembly includes an elongated tongue adapted for connection with the busbar. The terminal assembly also includes a tubular body disposed about a central axis. The tubular body has an end-wall integral with one end of the elongated tongue. The elongated tongue extends from a mid-portion of the end-wall such that the elongated tongue is co-axial with the central axis. The tubular body has a recess extending partway along its length. The terminal assembly further includes a ferrule coaxial with the tubular body. The ferrule has a tubular portion and a projection axially extending therefrom. The projection is adapted for receipt by the recess of the tubular body to contact with the tubular body. The tubular portion defines a cylindrical recess to receive the free end of the cable therein. At least one of the tubular body and the ferrule defines a plurality of external threads. The terminal assembly includes a coupling member defining a plurality of internal threads to engage with the plurality of external threads on at least one of the tubular body and the ferrule to removably secure the ferrule with the tubular body to establish electrical connectivity between the cable and the busbar.

The present disclosure is also directed to a machine having an electrical component and employing the terminal assembly disclosed herein.

Other features and aspects of this disclosure will be apparent from the following description and the accompanying drawings.

### BRIEF DESCRIPTION OF THE DRAWINGS

FIG. 1 is a schematic side view of an exemplary machine;

FIG. 2 is a block diagram of a drive system associated with the exemplary machine of FIG. 1;

FIG. 3A is a schematic perspective view of a system having a terminal assembly for the exemplary machine of FIG. 1, according to an embodiment of the present disclosure;

FIG. 3B is an exploded view of the terminal assembly of FIG. 3A;

FIG. 4 is a cross-sectional view of the terminal assembly of FIGS. 3A and 3B;

FIG. 5 is a schematic perspective view illustrating another design of a busbar coupled with the terminal assembly described in conjunction with FIGS. 3A and 3B;

FIG. 6A is a schematic perspective view of a terminal assembly for the exemplary machine of FIG. 1, according to another embodiment of the present disclosure;

FIG. 6B is an exploded view of the terminal assembly of FIG. 6A;

FIG. 7 is a cross-sectional view of the terminal assembly of FIGS. 6A and 6B;

FIG. 8A is a schematic perspective view of a terminal assembly for the exemplary machine of FIG. 1, according to yet another embodiment of the present disclosure;

FIG. 8B is an exploded view of the terminal assembly of FIG. 8A;

FIG. 9 is a cross-sectional view of the terminal assembly of FIGS. 8A and 8B; and

FIG. 10 is a schematic perspective view illustrating another design of a busbar coupled with the terminal assembly described in conjunction with FIGS. 8A and 8B.

### DETAILED DESCRIPTION

Wherever possible, the same reference numbers will be used throughout the drawings to refer to the same or like parts.

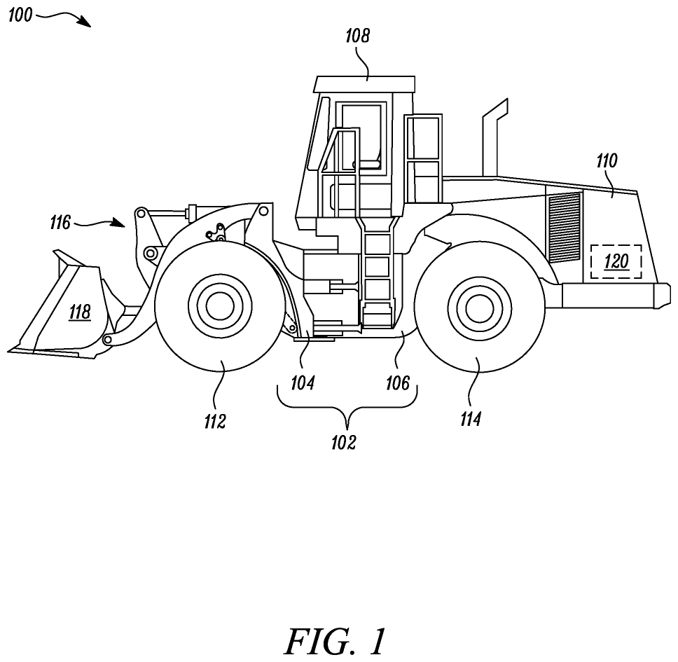

Referring to FIG. 1, a schematic side view of an exemplary machine 100 is illustrated. The machine 100 is embodied as a wheel loader that may be used for purposes, such as, but not limited to, construction, landscaping, or agriculture. Alternatively, the machine 100 may be embodied as an off-highway truck, a dozer, an excavator, a tractor, a motor grader, or a scraper, without any limitations, that may be used in various industries to move, remove, or load materials.

The machine 100 includes a frame 102. The frame 102 supports various components of the machine 100. The frame 102 includes a front frame 104 and a rear frame 106. The machine 100 also includes an operator cabin 108 supported by the rear frame 106. The machine 100 includes a hood 110 mounted on the rear frame 106. Further, the machine 100 includes a drive system 120 supported by the frame 102. The drive system 120 may include an electric drive system or a hybrid drive system. The hybrid drive system may include a combination of a fuel operated power source and electric components.

The frame 102 supports a pair of front wheels 112 and a pair of rear wheels 114. The front wheels 112 and the rear wheels 114 provide support and mobility to the machine 100 on grounds. Alternatively, the machine 100 may include tracks or drums instead of the wheels 112, 114.

The machine 100 also includes a linkage assembly 116. The linkage assembly 116 is movably coupled with the frame 102. The machine 100 further includes a work tool 118 movably coupled with the frame 102 via the linkage assembly 116. In the exemplary machine 100 of FIG. 1, the work tool 118 is shown embodied as a bucket that may be used for performing loading and unloading operations. In some examples, the work tool 118 may be any other type of work tool known in the art depending on specific machine type, configuration, or specific application requirements.

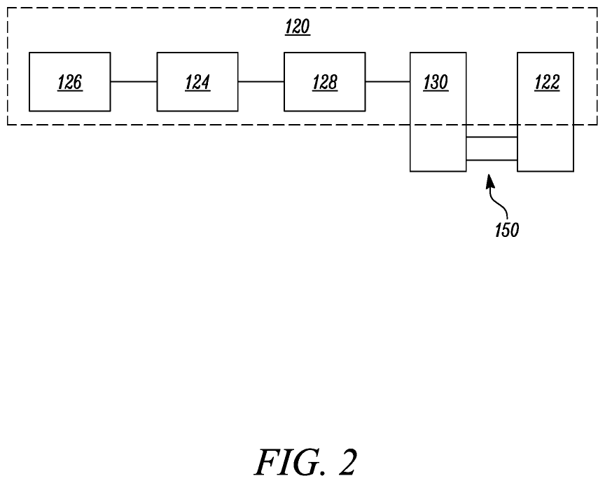

FIG. 2 illustrates a block diagram of the drive system 120 associated with the machine 100 of FIG. 1. The drive system 120 may include a motor 122, a generator 124, an engine 126, and a rectifier 128. In electric drive systems, the engine 126 may be replaced by a battery system (not shown). The machine 100 further includes an inverter 130. The inverter 130 forms a part of the drive system 120. The inverter 130 may allow the motor 122 to operate at variable speeds. The inverter 130 will hereinafter be referred to as “the electrical component” and denoted using identical reference numeral “130”.

The drive system 120 may provide power to various components of the machine 100 for operational and mobility requirements. In an example, the motor 122 may be embodied as a traction motor that may be used to move the front and rear wheels 112, 114 (see FIG. 1). The engine 126 may be an internal combustion engine. The engine 126 may produce an output torque to rotate a rotor (not shown) of the generator 124 to produce electrical power, for example, in the form of alternating current (AC) power. The electrical power may be supplied to the rectifier 128 and converted to direct current (DC) power. The rectified DC power may be converted again to AC power by the inverter 130. The machine 100 further includes a system 150. The system 150 electrically connects the inverter 130 and the motor 122.

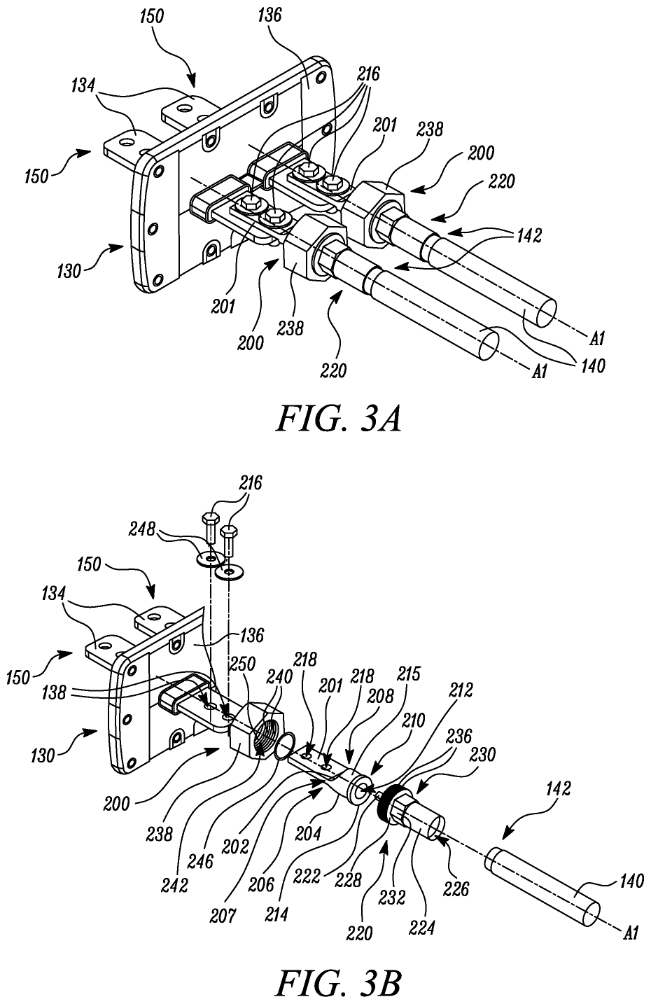

Referring to FIG. 3A, the present disclosure relates to the system 150 for creating an electrical junction. The system 150 includes a busbar 134. FIG. 3A illustrates two busbars 134 that are identical to each other in terms of design and functionality. Further, the machine 100 (see FIG. 1) includes the electrical component 130 and employs a terminal assembly 200. The busbar 134 is connected with the electrical component 130. Specifically, the busbar 134 is fixedly connected to a terminal block 136 of the electrical component 130. The busbar 134 is embodied as a flat rectangular plate herein. The busbar 134 defines a pair of openings 138 (shown in FIG. 3B). Although the system 150 connects the electrical component 130 with the motor 122 (see FIG. 2), the system 150 may be used to establish electrical connection between any two or more discrete components. Further, the terminal assembly 200 may be employed in battery systems, fuel cell systems, and the like. The system 150 further includes a cable 140 having a free end 142. The free end 142 of the cable 140 is to be electrically connected with the busbar 134. Further, another end (not shown) of the cable 140 is connected with the motor 122. The cable 140 may be thick enough to be usable in high-voltage applications for transmitting electrical power. Alternatively, the cable 140 may be usable in low-voltage applications or medium-voltage applications, as per application requirements. Further, the cable 140 includes a conductive core made of any material, such as, copper, and an insulation layer that surrounds the conductive core. The system 150 further includes the terminal assembly 200 for the cable 140. FIG. 3A illustrates two terminal assemblies 200 that are identical to each other in terms of design and functionality. Each terminal assembly 200 electrically connects the electrical component 130 and a corresponding cable 140, via the busbar 134.

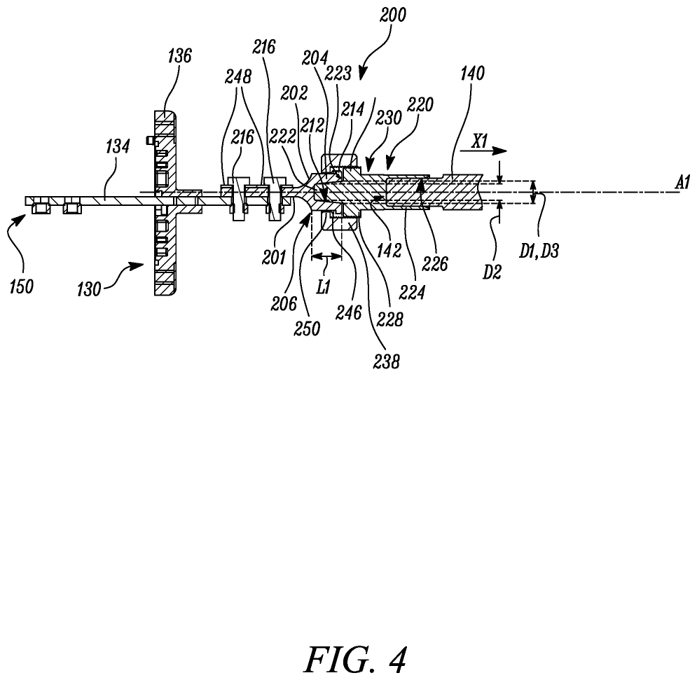

Referring to FIG. 3B, the terminal assembly 200 includes an elongated tongue 201 for connection with the busbar 134. The terminal assembly 200 also includes a tubular body 204 disposed about a central axis A1. The tubular body 204 has an end-wall 202 integral with one end 206 of the elongated tongue 201. The elongated tongue 201 extends from a mid-portion 207 of the end-wall 202 such that the elongated tongue 201 is co-axial with the central axis A1. The tubular body 204 has a recess 212 extending partway along its length L1 (shown in FIG. 4). Further, the tubular body 204 defines a first end 208 and a second end 210. The recess 212 extends from the second end 210 towards the first end 208. The recess 212 of the tubular body 204 tapers along the central axis A1, such that the recess 212 defines a larger diameter D1 (shown in FIG. 4) at the end 210 of the tubular body 204 disposed proximal to a ferrule 220. Further, the recess 212 defines a smaller diameter D2 (shown in FIG. 4) proximal to the first end 208. The tubular body 204 has a first radial projection 214 extending from an outer surface 215 of the tubular body 204 to form the end 210 of the tubular body 204 disposed proximal to the ferrule 220

In the illustrated embodiment of FIG. 3B, the elongated tongue 201 and the tubular body 204 are separate from the busbar 134. In other words, the elongated tongue 201 and the tubular body 204 are manufactured as a one-piece component for coupling with the busbar 134. In such an embodiment, a portion of the elongated tongue 201 overlaps and abuts with a portion of the busbar 134.

Further, the terminal assembly 200 includes one or more mechanical fasteners 216 to removably couple the elongated tongue 201 and the busbar 134. Specifically, the terminal assembly 200 includes two mechanical fasteners 216 herein. Alternatively, the terminal assembly 200 may include more than two mechanical fasteners 216 or a single mechanical fastener 216, depending on dimensions of the elongated tongue 201. The mechanical fasteners 216 are embodied as bolts herein. Alternatively, the mechanical fasteners 216 may include a screw, a pin, and the like, without any limitations. Further, the elongated tongue 201 defines one or more holes 218 to receive a corresponding mechanical fastener 216 from the one or more mechanical fasteners 216 therethrough. Specifically, the elongated tongue 201 includes two holes 218 herein. The holes 218 are embodied as through-holes. Alternatively, the elongated tongue 201 may include more than two holes 218 or a single hole 218. The two holes 218 in the elongated tongue 201 align with the openings 138 in the busbar 134 to receive the two mechanical fasteners 216 to removably couple the elongated tongue 201 and the busbar 134.

The terminal assembly 200 also includes the ferrule 220 coaxial with the tubular body 204. In one example, the elongated tongue 201, the tubular body 204, and the ferrule 220 may be made from copper. Alternatively, the elongated tongue 201, the tubular body 204, and the ferrule 220 may be made of any other metallic material. The ferrule 220 has a tubular portion 224 and a projection 222 axially extending therefrom. The projection 222 is received by the recess 212 of the tubular body 204 to contact the tubular body 204. The projection 222 of the ferrule 220 tapers along the central axis A1, such that the projection 222 defines a larger diameter D3 (shown in FIG. 4) at an end 223 (shown in FIG. 4) of the projection 222 that is coupled with the tubular portion 224.

Further, the tubular portion 224 defines a cylindrical recess 226 to receive the free end 142 of the cable 140 therein. The free end 142 of the cable 140 is crimped with the tubular portion 224. The ferrule 220 further includes a second radial projection 228 extending from the tubular portion 224 and located proximal to the projection 222. Specifically, the second radial projection 228 is disposed adjacent to the projection 222 along the central axis A1

The ferrule 220 further includes a means 230 to grip the ferrule 220 to torque a coupling member 238 against the ferrule 220. Specifically, the means 230 is embodied as a tool engaging section disposed adjacent to the first radial projection 214. Further, the means 230 includes a curvilinear outer surface 232. Specifically, the curvilinear outer surface 232 includes six tool engaging surfaces, such that the means 230 has a hexagonal cross-section. Alternatively, the means 230 may define two, four, or eight tool engaging surfaces, without any limitations. The curvilinear outer surface 232 of the means 230 may contact a tool (not shown), such as, a spanner or a wrench, during assembly of the terminal assembly 200. In other examples, the curvilinear outer surface 232 may be replaced by a knurled outer surface. It should be noted that the means 230 may have any other design that may allow gripping of the ferrule 220.

Further, the tubular body 204 or the ferrule 220 defines a number of external threads 236. In the illustrated embodiment of FIG. 3B, the ferrule 220 defines the number of external threads 236. Specifically, the number of external threads 236 are located on the second radial projection 228 of the ferrule 220.

The terminal assembly 200 further includes the coupling member 238 defining a number of internal threads 240 to engage with the number of external threads 236 of the ferrule 220 to removably secure the ferrule 220 with the tubular body 204 to establish electrical connectivity between the ferrule 220 and the tubular body 204. Thus, the coupling member 238 removably secures the tubular body 204 and the ferrule 220. The coupling member 238 is embodied as a hexagonal nut 238 herein. The coupling member 238 will hereinafter be referred to as “the hexagonal nut” and denoted using identical reference numeral “238”.

Further, the hexagonal nut 238 defines a through-hole 242. The through-hole 242 of the coupling member 238 at least partially receives each of the tubular body 204 and the ferrule 220 in order to removably secure the tubular body 204 with the ferrule 220. Further, the hexagonal nut 238 has an internal flange 250 that abuts with one or more washers 246. The internal flange 250 may prevent inadvertent unscrewing or removal of the hexagonal nut 238. In one example, the coupling member 238 may be made of steel, or any other metallic material. It should be noted that the coupling member 238 may include any other design to serve the intended purpose.

The terminal assembly 200 also includes the one or more washers 246 positioned between the coupling member 238, and the tubular body 204 or the ferrule 220. In the illustrated embodiment of FIG. 3B, the terminal assembly 200 includes the single washer 246. The washer 246 is disposed between the coupling member 238 and the tubular body 204. Specifically, the washer 246 is disposed between the first radial projection 214 of the tubular body 204 and the internal flange 250. The washer 246 may include a Belleville washer, a disc-spring washer, or a wave washer, without any limitations.

The terminal assembly 200 further includes a pair of washers 248. Upon receipt of the mechanical fastener 216 within the opening 138 in the busbar 134 and the hole 218 in the elongated tongue 201, each washer 248 surrounds a corresponding mechanical fastener 216 and is disposed adjacent to the elongated tongue 201. The washers 248 are embodied as flat washers herein. Alternatively, the washers 248 may include any other type of washers.

Referring to FIG. 4, in order to establish electrical connectivity between the cable 140 and the busbar 134, the cable 140 is crimped to the tubular portion 224 of the ferrule 220. Further, to couple the tubular body 204 with the ferrule 220, the projection 222 of the ferrule 220 is received within the recess 212 of the tubular body 204. The coupling member 238 is then threadedly engaged with the ferrule 220, thereby securing the tubular body 204 with the ferrule 220. It should be noted that the coupling member 238 is moved in a direction X1 along the central axis A1 to be threadedly engaged with the ferrule 220. Subsequently, the washers 248 and the mechanical fasteners 216 are coupled with the elongated tongue 201 and the busbar 134, thereby removably coupling the terminal assembly 200 with the busbar 134.

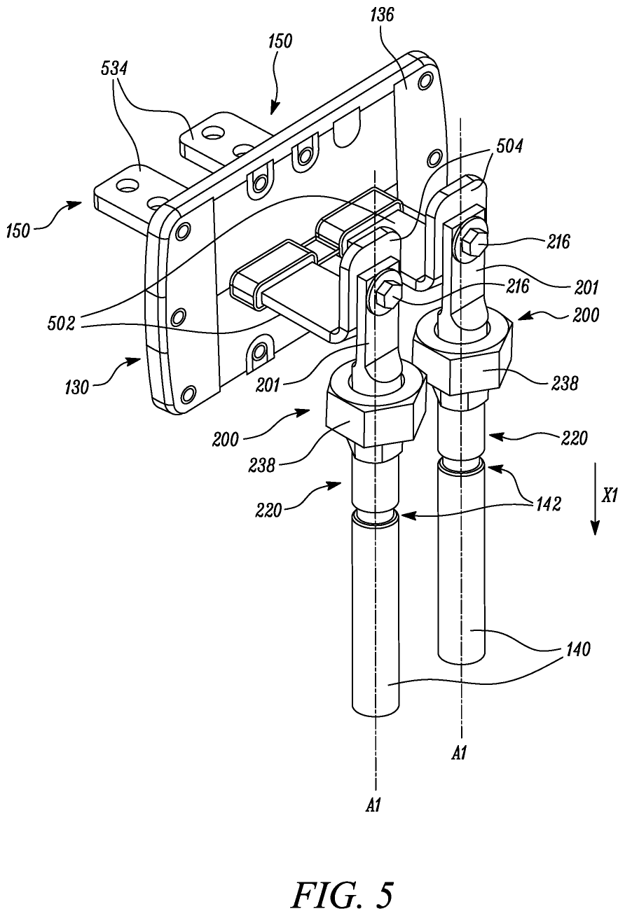

FIG. 5 illustrates another design of a busbar 534. The busbar 534 includes a first section 502 and a second section 504 extending orthogonally from the first section 502. The first section of the busbar 534 is coupled with the terminal block 136 of the electrical component 130. As shown in FIG. 5, the terminal assembly 200 explained in conjunction with FIGS. 3A to 4 is removably coupled with the busbar 534 to establish electrical connectivity between the cable 140 and the busbar 534. Same components are referred using the same numbers. However, the terminal assembly 200 is removably coupled with the second section 504 of the busbar 534. Thus, when the terminal assembly 200 is coupled with the busbar 534, the second section 504 contacts with the elongated tongue 201. Further, each terminal assembly 200 includes only one mechanical fastener 216 herein. Furthermore, the second section 504 of the busbar 534 includes a single opening (not shown) and the elongated tongue 201 includes a single hole (not shown) to receive the single mechanical fastener 216. It should be noted that the coupling member 238 is moved in the direction X1 along the central axis A1 to be threadedly engaged with the ferrule 220.

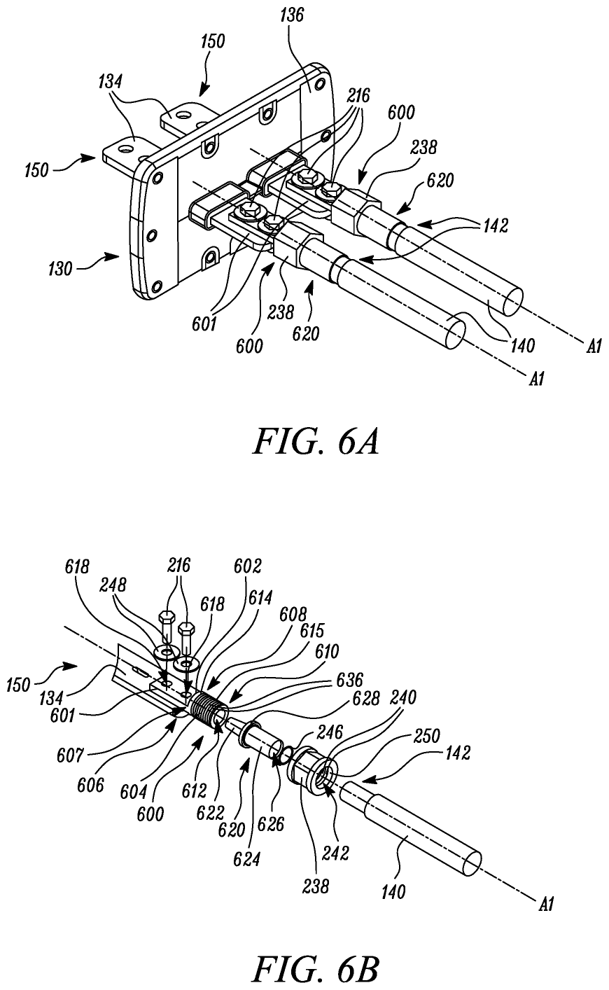

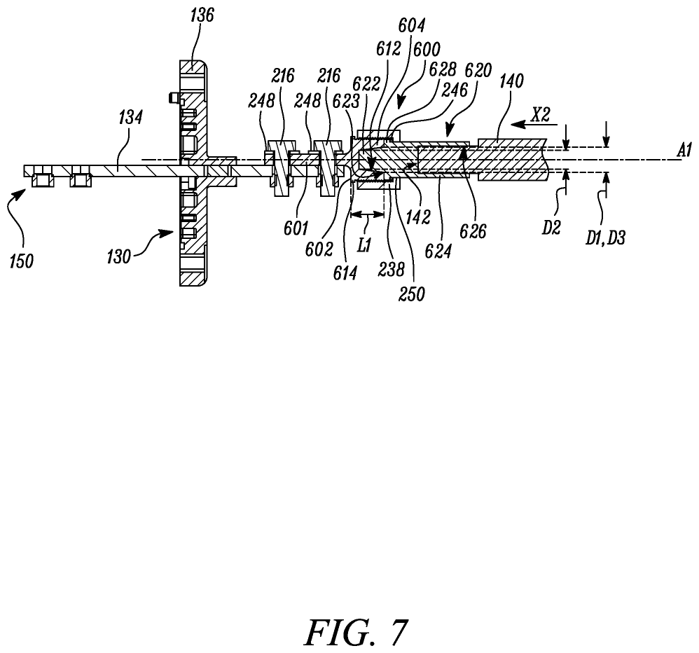

FIGS. 6A, 6B, and 7 illustrate a terminal assembly 600 for the cable 140, according to another embodiment of the present disclosure. The terminal assembly 600 is substantially similar to the terminal assembly 200 explained in conjunction with FIGS. 3A, 3B, and 4. Same components are referred using the same numbers. FIG. 6A illustrates two terminal assemblies 600 that are identical to each other in terms of design and functionality. Each terminal assembly 600 electrically connects the electrical component 130 and a corresponding cable 140, via the busbar 134.

As shown in FIG. 6B, the terminal assembly 600 includes an elongated tongue 601 for connection with the busbar 134. The terminal assembly 600 also includes a tubular body 604 disposed about a central axis A1. The tubular body 604 has an end-wall 602 integral with one end 606 of the elongated tongue 601. The elongated tongue 601 extends from a mid-portion 607 of the end-wall 602 such that the elongated tongue 601 is co-axial with the central axis A1. The tubular body 604 has a recess 612 extending partway along its length L1 (shown in FIG. 7). Further, the tubular body 604 defines a first end 608 and a second end 610. The recess 612 extends from the second end 610 towards the first end 608. The recess 612 of the tubular body 604 tapers along the central axis A1, such that the recess 612 defines a larger diameter D1 (shown in FIG. 7) at the end 610 of the tubular body 604 disposed proximal to a ferrule 620. Further, the recess 612 defines a smaller diameter D2 (shown in FIG. 7) proximal to the first end 608. The tubular body 604 has a first radial projection 614 extending from an outer surface 615 of the tubular body 604 to form the end 608 of the tubular body 604 disposed proximal to the elongated tongue 601. In the illustrated embodiment of FIG. 6B, the elongated tongue 601 and the tubular body 604 are separate from the busbar 134. In other words, the elongated tongue 601 and the tubular body 604 are manufactured as a one-piece component for coupling with the busbar 134.

Further, the elongated tongue 601 defines one or more holes 618 to receive a corresponding mechanical fastener 216 from the one or more mechanical fasteners 216 therethrough. Specifically, the elongated tongue 601 includes two holes 618 herein. The holes 618 are embodied as through-holes. Alternatively, the elongated tongue 601 may include more than two holes 618 or a single hole 618. The two holes 618 in the elongated tongue 601 align with the openings 138 (see FIG. 3B) in the busbar 134 to receive the two mechanical fasteners 216 to removably couple the elongated tongue 601 and the busbar 134.

The terminal assembly 600 also includes the two mechanical fasteners 216. The terminal assembly 600 further includes the ferrule 620 coaxial with the tubular body 604. In one example, the elongated tongue 601, the tubular body 604, and the ferrule 620 may be made from copper. Alternatively, the elongated tongue 601, the tubular body 604, and the ferrule 620 may be made of any other metallic material. The ferrule 620 has a tubular portion 624 and a projection 622 axially extending therefrom. The projection 622 is received by the recess 612 of the tubular body 604 to contact the tubular body 604. The projection 622 of the ferrule 620 tapers along the central axis A1, such that the projection 622 defines a larger diameter D3 (shown in FIG. 7) at an end 623 (shown in FIG. 7) of the projection 622 that is coupled with the tubular portion 624.

Further, the tubular portion 624 defines a cylindrical recess 626 to receive the free end 142 of the cable 140 therein. The free end 142 of the cable 140 is crimped with the tubular portion 624. The ferrule 620 further includes a second radial projection 628 extending from the tubular portion 624 and located proximal to the projection 622. The second radial projection 628 is disposed adjacent to the projection 622 along the central axis A1.

Further, the tubular body 604 or the ferrule 620 defines a number of external threads 636. In the illustrated embodiment of FIG. 6B, the tubular body 604 defines the number of external threads 636. Specifically, the number of external threads 636 is located on the tubular body 604. The terminal assembly 600 also includes the coupling member 238. The terminal assembly 600 further includes the washer 246 and the pair of washers 248. Further, the washer 246 is disposed between the second radial projection 628 of the ferrule 620 and the internal flange 250.

Referring to FIG. 7, in order to establish electrical connectivity between the cable 140 and the busbar 134, the cable 140 is crimped to the tubular portion 624 of the ferrule 620. Further, to couple the tubular body 604 with the ferrule 620, the projection 622 of the ferrule 620 is received within the recess 612 of the tubular body 604. The coupling member 238 is then threadedly engaged with the tubular body 604, thereby securing the tubular body 604 with the ferrule 620. It should be noted that the coupling member 238 is moved in a direction X2 along the central axis A1 to threadedly engage the coupling member 238 with the tubular body 604. The direction X2 is opposite to the direction X1 shown in FIG. 4. Subsequently, the washers 248 and the mechanical fasteners 216 are coupled with the elongated tongue 601 and the busbar 134, thereby removably coupling the terminal assembly 600 with the busbar 134.

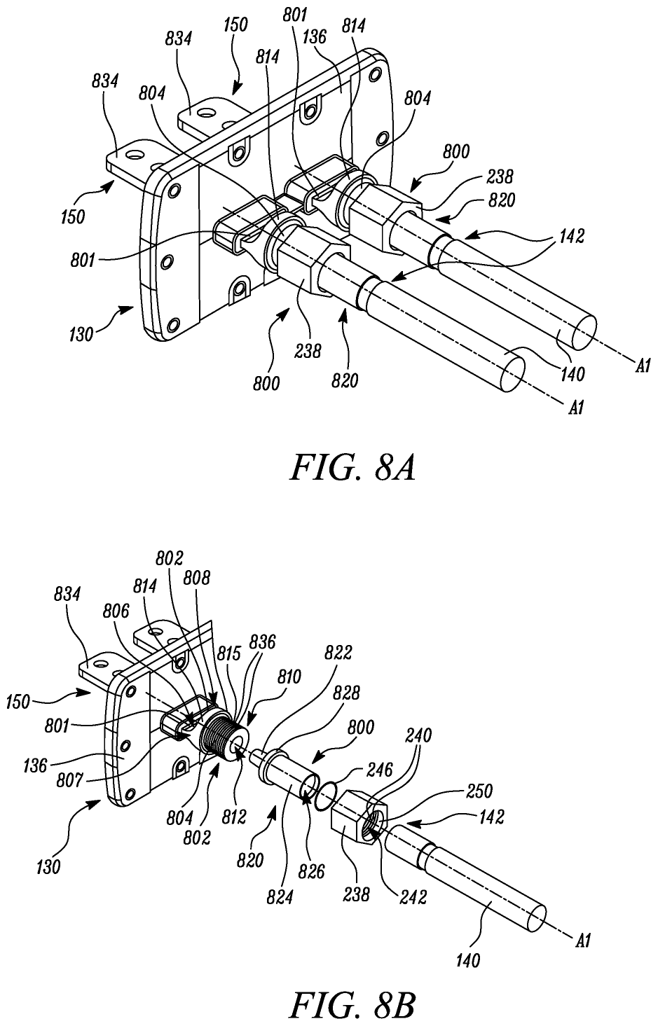

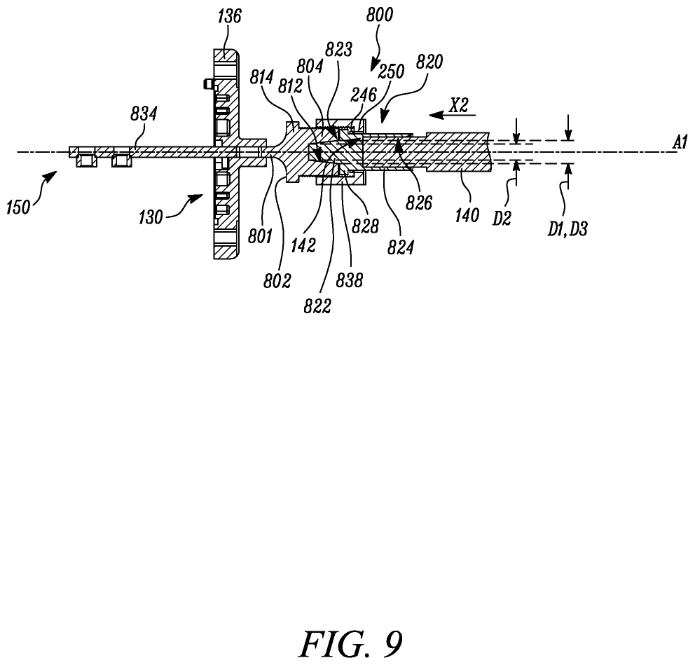

FIGS. 8A, 8B, and 9 illustrates a terminal assembly 800 for the cable 140, according to yet another embodiment of the present disclosure. The terminal assembly 800 is substantially similar to the terminal assembly 200 explained in conjunction with FIGS. 3A, 3B, and 4. Same components are referred using the same numbers. FIG. 8A illustrates two terminal assemblies 800 that are identical to each other in terms of design and functionality. Each terminal assembly 800 electrically connects the electrical component 130 and a corresponding cable 140, via the busbar 834.

Referring to FIG. 8B, the terminal assembly 800 includes an elongated tongue 801 for connection with the busbar 834. The terminal assembly 800 also includes a tubular body 804 disposed about a central axis A1. The tubular body 804 has an end-wall 802 integral with one end 806 of the elongated tongue 801. The elongated tongue 801 extends from a mid-portion 807 of the end-wall 802 such that the elongated tongue 801 is co-axial with the central axis A1. The tubular body 804 has a recess 812 extending partway along its length L1 (shown in FIG. 9). Further, the tubular body 804 defines a first end 808 and a second end 810. The recess 812 extends from the second end 810 towards the first end 808. The recess 812 of the tubular body 804 tapers along the central axis A1, such that the recess 812 defines a larger diameter D1 (shown in FIG. 9) at the end 810 of the tubular body 804 disposed proximal to a ferrule 820. Further, the recess 812 defines a smaller diameter D2 (shown in FIG. 9) proximal to the first end 808. The tubular body 804 has a first radial projection 814 extending from an outer surface 815 of the tubular body 804 to form the end 808 of the tubular body 804 disposed proximal to the elongated tongue 801.

In the illustrated embodiment of FIG. 8B, the elongated tongue 801 is integrally formed with the busbar 834. In other words, the elongated tongue 801, the tubular body 804, and the busbar 834 are manufactured as a single component. Further, the tubular body 804 and the busbar 834 are co-planar. In one example, the elongated tongue 801, the tubular body 804, the terminal block 136, and the busbar 834 may be fixedly coupled with each other. For example, the terminal block 136 may be molded with the elongated tongue 801, the tubular body 804, and the busbar 834. It should be noted that a length of the elongated tongue 801 defined between the busbar 134 and the tubular body 804 is considerably lesser when compared to a length of the elongated tongue 201 (see FIGS. 3B and 4) of the terminal assembly 200 (see FIGS. 3B and 4).

The terminal assembly 800 also includes the ferrule 820 coaxial with the tubular body 804. In one example, the elongated tongue 801, the tubular body 804, and the ferrule 820 may be made from copper. Alternatively, the elongated tongue 801, the tubular body 804, and the ferrule 820 may be made of any other metallic material. The ferrule 820 has a tubular portion 824 and a projection 822 axially extending therefrom. The projection 822 is received by the recess 812 of the tubular body 804 to contact the tubular body 804. The projection 822 of the ferrule 820 tapers along the central axis A1, such that the projection 822 defines a larger diameter D3 (shown in FIG. 9) at an end 823 (shown in FIG. 9) of the projection 822 that is coupled with the tubular portion 824.

Further, the tubular portion 824 defines a cylindrical recess 826 to receive the free end 142 of the cable 140 therein. The free end 142 of the cable 140 is crimped with the tubular portion 824. The ferrule 820 further includes a second radial projection 828 extending from the tubular portion 824 and located proximal to the projection 822. The second radial projection 828 is disposed adjacent to the projection 822 along the central axis A1.

Further, the tubular body 804 or the ferrule 820 defines a number of external threads 836. In the illustrated embodiment of FIG. 8B, the tubular body 804 defines the number of external threads 836. Specifically, the number of external threads 836 is located on the tubular body 804.

The terminal assembly 800 also includes the coupling member 238. The terminal assembly 800 further includes the washer 246 and the pair of washers 248. Further, the washer 246 is disposed between the second radial projection 828 of the ferrule 820 and the internal flange 250.

Referring to FIG. 9, in order to establish electrical connectivity between the cable 140 and the busbar 834, the cable 140 is crimped to the tubular portion 824 of the ferrule 820. Further, to couple the tubular body 804 with the ferrule 820, the projection 822 of the ferrule 820 is received within the recess 812 of the tubular body. The coupling member 238 is then threadedly engaged with the tubular body 804, thereby securing the tubular body 804 with the ferrule 820. It should be noted that the coupling member 238 is moved in the direction X2 along the central axis A1 to threadedly engage the coupling member 238 with the tubular body 804.

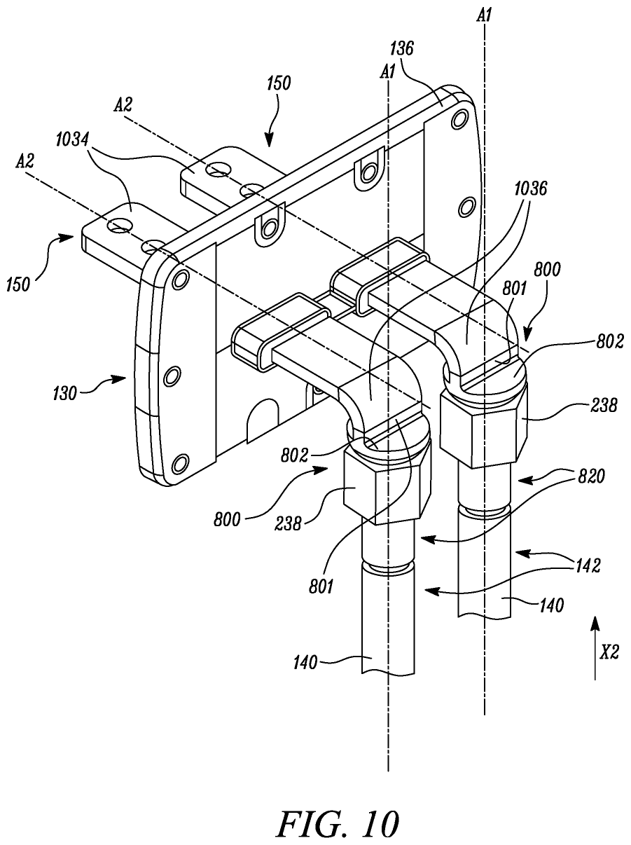

FIG. 10 illustrates a busbar 1034 and the terminal assembly 800 coupled with the busbar 1034, according to yet another embodiment of the present disclosure. The terminal assembly 800 includes the tubular body 804. In the illustrated embodiment of FIG. 10, the tubular body 804 is integral with the busbar 1034. In other words, the elongated tongue 801, the tubular body 804, and the busbar 1034 are manufactured as a single component. Thus, the elongated tongue 801 and the tubular body 804 are integrally coupled with the busbar 1034. Further, the busbar 1034 extends along an axis A2 that is orthogonal to the central axis A1, such that the tubular body 804 and the busbar 1034 are orthogonal to each other. The elongated tongue 801 of the tubular body 804 is integrally coupled with the busbar 1034 via a curved portion 1036. It should be noted that the coupling member 238 is moved in the direction X2 along the central axis A1 to be threadedly engaged with the ferrule 820.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the terminal assembly 200, 600, 800 for electrically connecting the cable 140 with the busbar 134, 534, 834, 1034. The terminal assembly 200, 600, 800 of the present disclosure may allow rotation of the cable 140 relative to the busbar 134, 534, 834, 1034 in order to dispose the cable 140 in a desired orientation, prior to installation, without requiring specialized tools and fixtures. The ferrule 220, 620, 820 of the terminal assembly 200, 600, 800 is rotatable about the central axis A1 relative to the tubular body 204, 604, 804. Thus, based on an orientation of the cable 140, the ferrule 220, 620, 820 may be positioned in a desired orientation prior to the coupling of the ferrule 220, 620, 820 and the tubular body 204, 604, 804, thereby accommodating twists in the cable 140.

Further, the terminal assembly 200, 600, 800 may eliminate a requirement of specialized and heavy tools/fixtures for connecting the cable 140 with the busbar 134, 534, 834, 1034. The terminal assembly 200, 600, 800 may also simplify an assembly process of the cable 140 with the busbar 134, 534, 834, 1034, while significantly reducing assembly time and overall costs associated with the system 150. Further, the terminal assembly 200, 600, 800 may be used across various machines. Overall, the terminal assembly 200, 600, 800, when compared to conventional terminal assemblies, may be cost-effective, may include fewer mating parts, may be retrofitted on existing machines, may be easy to handle, and may have a simple design.

The terminal assembly 200, 600, 800 may also provide a high-performance electrical connection by providing a good surface finish, fewer junction interfaces due to fewer mating parts, higher electrical contact area, and higher contact pressure. Moreover, the same design of the terminal assembly 200, 600 may be used for the busbars 134, 534 shown in FIGS. 3A, 5, and 6. Further, the same design of the terminal assembly 800 may be used for the busbars 834, 1034, shown in FIGS. 8A and 10.

The terminal assembly 200, 600, 800 may be accommodated in compact workspaces. The terminal assembly 200, 600, 800 may also provide a reliable electrical connection due to the robust mechanical connection between the components of the terminal assembly 200, 600, 800. Moreover, the terminal assembly 200, 600, 800 may be usable in machines operating in harsh environments, as the components of the terminal assembly 200, 600, 800 have a robust design and may exhibit improved resistance against vibration, temperature, moisture, dust, and debris.

Each terminal assembly 200, 600, 800 includes the washer 246. The washer 246 may assure a minimum electrical joint compression force over a period of time and temperature due to setting and thermal expansion/contraction. The washer 246 may also compensate clamp load losses and may sustain clamp loads over a long period of time, which may be essential for maintaining the high-performance electrical connection.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of the disclosure. Such embodiments should be understood to fall within the scope of the present disclosure as determined based upon the claims and any equivalents thereof.

What is claimed is:

1. A terminal assembly for a cable, the terminal assembly comprising:
an elongated tongue adapted for connection with a busbar;
a tubular body disposed about a central axis, the tubular body having an end-wall integral with one end of the elongated tongue, the elongated tongue extending from a mid-portion of the end-wall such that the elongated tongue is co-axial with the central axis, the tubular body having a recess extending partway along its length;
a ferrule coaxial with the tubular body, the ferrule having a tubular portion and a projection axially extending therefrom, the projection adapted for receipt by the recess of the tubular body to contact with the tubular body, the tubular portion defining a cylindrical recess to receive a free end of the cable therein, wherein at least one of the tubular body and the ferrule defines a plurality of external threads; and
a coupling member defining a plurality of internal threads to engage with the plurality of external threads on at least one of the tubular body and the ferrule to removably secure the ferrule with the tubular body to establish electrical connectivity between the cable and the busbar.

2. The terminal assembly of claim 1, wherein the elongated tongue is integrally formed with the busbar.

3. The terminal assembly of claim 1, wherein a portion of the elongated tongue overlaps and abuts with a portion of the busbar, and wherein the terminal assembly further includes at least one mechanical fastener configured to removably couple the elongated tongue and the busbar.

4. The terminal assembly of claim 3, wherein the elongated tongue defines one or more holes configured to receive a corresponding mechanical fastener from the at least one mechanical fastener therethrough.

5. The terminal assembly of claim 1, wherein the tubular body has a first radial projection extending from an outer surface of the tubular body to form an end of the tubular body disposed proximal to at least one of the ferrule and the elongated tongue.

6. The terminal assembly of claim 1, wherein the plurality of external threads is located on the tubular body.

7. The terminal assembly of claim 1, wherein the ferrule includes a second radial projection extending from the tubular portion and located proximal to the projection.

8. The terminal assembly of claim 7, wherein the plurality of external threads is located on the second radial projection of the ferrule.

9. The terminal assembly of claim 8 further comprising at least one washer positioned between the coupling member and one of the tubular body and the ferrule.

10. The terminal assembly of claim 9, wherein the coupling member is a hexagonal nut, and wherein the hexagonal nut has an internal flange that abuts with the at least one washer.

11. The terminal assembly of claim 1, wherein the tubular portion of the ferrule defines a means to grip the ferrule to torque the coupling member against the ferrule.

12. The terminal assembly of claim 1, wherein the recess of the tubular body tapers along the central axis, such that the recess defines a larger diameter at an end of the tubular body disposed proximal to the ferrule.

13. The terminal assembly of claim 1, wherein the projection of the ferrule tapers along the central axis, such that the projection defines a larger diameter at an end of the projection that is coupled with the tubular portion.

14. A machine comprising:
an electrical component and employing the terminal assembly of claim 1.

15. A system for creating an electrical junction, the system comprising:
a busbar;
a cable having a free end; and
a terminal assembly for the cable, the terminal assembly including:
an elongated tongue adapted for connection with the busbar;
a tubular body disposed about a central axis, the tubular body having an end-wall integral with one end of the elongated tongue, the elongated tongue extending from a mid-portion of the end-wall such that the elongated tongue is co-axial with the central axis, the tubular body having a recess extending partway along its length;
a ferrule coaxial with the tubular body, the ferrule having a tubular portion and a projection axially extending therefrom, the projection adapted for receipt by the recess of the tubular body to contact with the tubular body, the tubular portion defining a cylindrical recess to receive the free end of the cable therein, wherein at least one of the tubular body and the ferrule defines a plurality of external threads; and
a coupling member defining a plurality of internal threads to engage with the plurality of external threads on at least one of the tubular body and the ferrule to removably secure the ferrule with the tubular body to establish electrical connectivity between the cable and the busbar.

16. The system of claim 15, wherein the elongated tongue is integrally formed with the busbar.

17. The system of claim 15, wherein a portion of the elongated tongue overlaps and abuts with a portion of the busbar, and wherein the terminal assembly further includes at least one mechanical fastener configured to removably couple the elongated tongue and the busbar.

18. The system of claim 15, wherein the plurality of external threads is located on the tubular body.

19. The system of claim 15, wherein the ferrule includes a radial projection extending from the tubular portion and located proximal to the projection, and wherein the plurality of external threads is located on the radial projection of the ferrule.

20. The system of claim 15 further comprising at least one washer positioned between the coupling member and one of the tubular body and the ferrule.
